(19) United States
(12) Patent Application Publication
(10) Pub. No.: US 2007/0003908 A1
(43) Pub. Date: Jan. 4, 2007

(54) Dental crown composed of anodized titanium

(75) Inventor: Dan Porter, Naperville, IL (US)

Correspondence Address: THE LAW OFFICE OF RANDALL T. ERICKSON, P.C., 425 WEST WESLEY STREET, SUITE 1, WHEATON, IL, 60187, US

(73) Assignee: Sequoia Dental Studio, LLC

(21) Appl. No.: 11/174,111

(22) Filed: Jul. 1, 2005

(51) Int. Cl. A61C 5/08; A61C 5/10

(52) U.S. Cl. 433/223; 433/218

(57) ABSTRACT

A dental crown includes a formed crown body simulating the contours of a natural tooth, composed of anodized titanium and permanently secured onto an abutment that is fixed into the patient's mouth. The crown body can include a ceramic layer, such as porcelain, adhered to, and overlaid on, the body. The body is preferably anodized to the extent that it displays a gold color, although other colors and varying shades are possible and effectively selectable by controlled use of the anodizing process.

### TECHNICAL FIELD OF THE INVENTION

The present invention is directed to dental prostheses, particularly to crowns that are mounted to natural or artificial base portions or abutments.

### BACKGROUND OF THE INVENTION

In dentistry, there is a need to provide prostheses for constructing or repairing teeth. Crowns having various structures are known. For example, U.S. Pat. Nos. 5,288,232; 5,346,396 or 6,159,011 disclose dental prostheses comprising a ceramic structure mounted on a titanium implant or abutment. U.S. Pat. No. 5,984,683 discloses a denture comprising a formed titanium crown base over which a porcelain layer or overlay is formed.

Titanium is a substantially biocompatible material that is advantageously used for dental components. However, titanium displays a metallic or gray color which is aesthetically unattractive for an artificial tooth or portion thereof. Even when the titanium forms a base layer over which a translucent porcelain is applied, the color of the titanium beneath the porcelain causes the artificial tooth to have an unattractive, unnatural color.

The present inventor has recognized that it would be advantageous to provide a crown material that does not display an unattractive color to an artificial tooth or tooth portion. The present inventor has recognized that it would be advantageous to provide a crown material that is relatively inexpensive compared to more exotic materials. The present inventor has recognized that it would be advantageous to provide a crown material that provides an attractive color to an artificial tooth or portion thereof, particularly when the crown material is overlaid with porcelain.

### SUMMARY OF THE INVENTION

The present invention provides a dental crown that includes a formed crown body simulating the contours of a natural tooth, composed of anodized titanium and permanently secured onto an abutment that is fixed into the patient's mouth. The crown body can include a ceramic layer adhered to, and overlaid on, the body. The ceramic layer can comprise porcelain.

The body is preferably anodized to the extent that it displays a gold color, although other colors and varying shades are possible and effectively selectable by controlled use of the anodizing process.

The invention provides a method of preparing and fitting a dental crown to a person that includes the steps of:

forming out of titanium a shaped piece having a tooth-surface contour;

anodizing the shaped piece; and

adhering the shaped-piece to an abutment extending down into a person's jaw bone.

The method can be used for dental restorations wherein the abutment comprises a portion of a natural tooth, or wherein the abutment comprises an artificial dental implant. The method can comprise the further step of applying a layer of ceramic material, preferably porcelain, on the shaped piece.

The invention provides a cost effective and visually attractive dental prosthesis that simulates the natural color of a patient's teeth. Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a perspective view of a crown in accordance with the present invention;

FIG. 2 is a sectional view taken generally along line 2-2 of from FIG. 1 showing the crown mounted on a portion of a natural tooth;

FIG. 3 is an alternate sectional view of a taken generally along line 2-2 of from FIG. 1 showing the crown mounted on a dental implant; and

FIG. 4 is an alternate embodiment crown.

### DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

FIG. 1 illustrates a portion of a person's mouth and teeth. An artificial tooth portion or crown 10 is fit onto and permanently secured to a prepared natural tooth portion or abutment 12 that is rooted into the patient's jawbone 13, beneath the gum line 14. By “permanently secured” it is meant that the crown is not removed by the patient or dentist in the normal course of use, but is intended to be in place for at least a number of years.

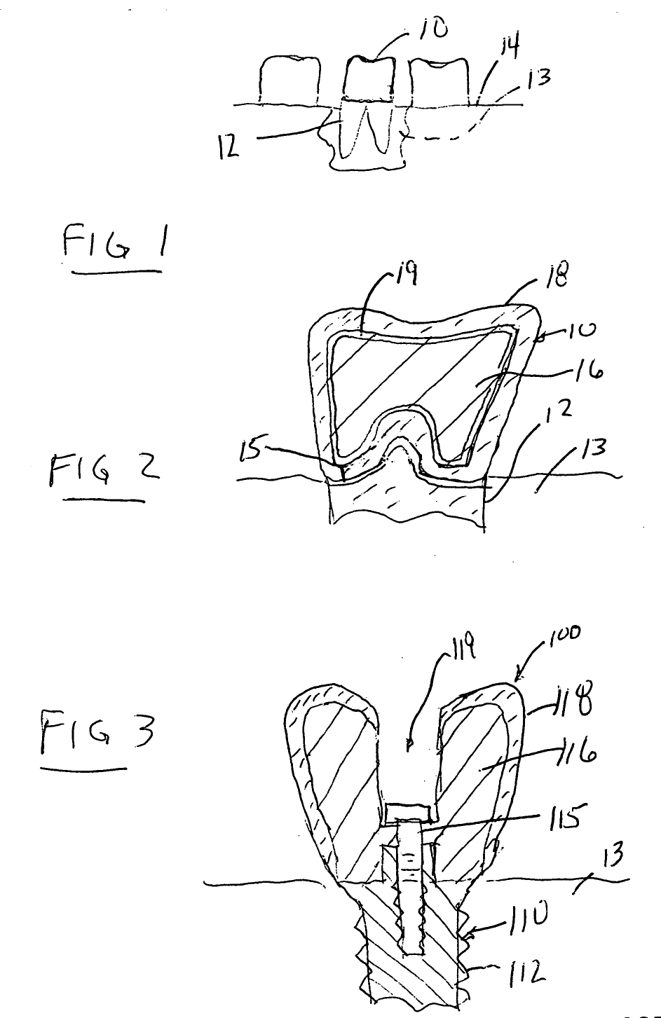

FIG. 2 illustrates in more detail the crown 10 fixed to the abutment 12. The crown is cemented by a layer of dental cement 15 such as a zinc phosphate cement, or as described in U.S. Pat. No. 4,828,495, herein incorporated by reference and modified according to the teachings of the present invention. The natural tooth portion is part of a tooth that has been prepared to receive the crown. The crown 10 includes a base 16 formed in the shape of a natural tooth, and an overlaid layer or cap 18. The cap 18 is preferably formed of porcelain or other ceramic material that simulates the texture of a natural tooth. The porcelain can be adhered with an adhesive layer 19 or composition as necessary and as known in the art such as described in U.S. Pat. Nos. 4, 879,136; 5,288,232; 5,314,334; or 6,159,011, herein incorporated by reference and modified according to the teachings of the present invention.

According to the preferred embodiment of the invention, the base 16 comprises an anodized titanium material that is anodized to the degree such that its color is gold or wheat colored. Given this color, the overall appearance of the tooth through the cap 18 that is somewhat translucent, is natural in color and similar to the color of the remaining teeth in the patient's mouth.

Aniodic oxidation or “anodizing” is a known electrochemical method used to increase the thickness of the oxide layer on metal parts. A current is applied in an electrolytic cell wherein the part is configured as the anode. When an electrical potential is applied to the part, the resulting current will transport oxygen-containing anions through he electrolyte. A continuous oxide TiO₂ is formed on the metal part.

The titanium crown base 16 may be oxidized by immersion in a suitable electrolyte and passing an electric current therethrough. The degree of anodizing can be adjusted to effect the color of the crown base 16 to match the patient's existing teeth or as desired.

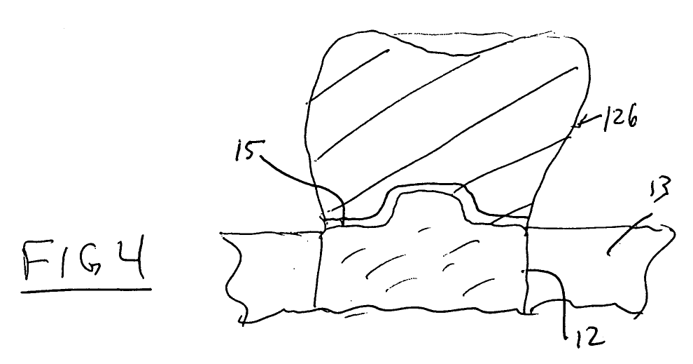

FIG. 3 illustrates a crown 100 fit onto a dental implant abutment 110, such as described in U.S. Pat. Nos. 6,663,387 or 5,833,463, herein incorporated by reference and modified according to the teachings of the present invention.

U.S. Pat. Nos. 4,879,136 and 5,288,232, herein incorporated by reference and modified according to the teachings of the present invention, describe techniques for bonding ceramic or porcelain crowns to metal posts or other substructure.

The abutment 110 is fixed into the patient's jawbone 13 by use of screw threads 112 or other technique known in the art. The crown 100 is fixed to the abutment 112 by use of a screw 115 or post, or cement, or other known method.

The crown 100 is identical to the crown 10 described above except that a base 116 and cap 118 include a central hole 119 for receiving the screw 115 for attaching the crown to the artificial abutment 112. The hole 119 can be filled with cement or other dental material after the crown 100 is attached. The layers 15 and 19 described with regard to FIG. 2 can be used as necessary.

According to the embodiment of FIG. 4, the outer cap 18 is eliminated. A single body 126, composed of anodized titanium is exposed and forms a gold-colored crown by the selective anodizing of a titanium material to achieve the desired color. The anodized titanium is more cost effective than a comparable gold crown. Although the body 126 is shown applied over a natural tooth abutment 12 by use of adhesive 15 similar to FIG. 1 and 2 but eliminating the cap 18, it can also be applied to an artificial abutment as per FIG. 3, but eliminating the cap 118.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A dental crown, comprising:
a formed crown body simulating the contours of a natural tooth, composed of anodized titanium and permanently secured onto an abutment that is fixed into the patient's mouth.

2. The crown according to claim 1, further comprising a ceramic layer adhered to, and overlaid on, said body.

3. The crown according to claim 2, wherein said ceramic layer comprises porcelain.

4. The crown according to claim 3, wherein said body is anodized to the extent to display a gold color.

5. A method of preparing and fitting a crown to a person, comprising the steps of:
forming out of titanium a shaped piece having a tooth-surface contour;
anodizing said shaped piece; and
adhering said shaped-piece to an abutment extending down into a person's jaw bone.

6. The method according to claim 5, wherein said abutment comprises a portion of a natural tooth.

7. The method according to claim 5, wherein said abutment comprises an artificial dental implant.

8. The method according to claim 5, comprising the further step of applying a layer of ceramic material on said shaped piece.

9. The method according to claim 8, wherein said ceramic material comprises porcelain.
